(19) United States
(12) Patent Application Publication
(10) Pub. No.: US 2002/0080441 A1
(43) Pub. Date: Jun. 27, 2002

(54) Optical cross-connect for optional interconnection of communication signals of different multiplex levels

(75) Inventors: Werner Beisel, Ludwigsburg (DE); Volker Hagele, Schorndorf (DE); Heinz Wettengel, Ditzingen (DE)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 10/020,176

(22) Filed: Dec. 18, 2001

(30) Foreign Application Priority Data
Dec. 23, 2000 (DE) 100 65 001.5

(51) Int. Cl. G02B 6/26; G02B 6/42; H04J 14/00

(52) U.S. Cl. 359/117; 385/17

(57) ABSTRACT

An optical cross-connect (OCX), which is designed for the switching of so-called Optical Channels of different multiplex levels with respectively defined bit rates, has a number of input/output ports (IO1, IO2, IO3) which are respectively adapted to transmit and receive communication signals of a particular multiplex level. The cross-connect furthermore has a space switching matrix (S) which is adapted to switch communication signals of the lowest multiplex level. Input/output ports (IO1) of the lowest multiplex level are connected directly to the switching matrix, and input/output ports (IO2, IO3) of the higher multiplex levels are respectively connected to the switching matrix via a multiplexer (MUX1, MUX2) which is adapted to multiplex a number of communication signals of the lowest multiplex level that are received from the switching matrix (S), so as to form a communication signal of the corresponding higher multiplex level, and to demultiplex a communication signal of the higher multiplex level that is received from the respective input/output port (IO2, IO3), so as to form a number of communication signals of the lowest multiplex level, and forward these individually to the switching matrix (S).

The invention is based on a priority application DE 10065001.5, which is incorporated by reference herein.

### FIELD OF THE INVENTION

The invention relates to the field of telecommunications and more particularly to an optical cross-connect for switching connections in an optical transmission network, in which optical communication signals of different multiplex levels with respectively defined bit rates can be transmitted, communication signals of a higher multiplex level being composed of communication signals of a lower multiplex level or directly containing a payload data signal.

### BACKGROUND OF THE INVENTION

In optical communication transmission, synchronous optical systems are currently used which are known in Europe as SDH (synchronous digital hierarchy) and in North America as SONET (synchronous optical network) systems. These systems define communication signals of different hierarchy levels, with communication signals of a higher multiplex level being composed of communication signals of a lower multiplex level or directly containing a payload data signal. The multiplex hierarchy of these systems is defined in ITU-T G.707, Chapter 6. An overview of these systems is presented in, for example, the article “SONET 101” by the Nortel Networks company, which can be downloaded from the Internet address

www.nortel.com/broadband/pdf/sonet 101. pdf.

In optical communication transmission networks, cross-connects are used which have the function of establishing paths in the network. For this purpose, it is necessary to be able to switch multiplex units from each input to each output. Known in the art are so-called 4/3/1 cross-connects such as, for example, the 1641SX of the Alcatel company, which are able to switch multiplex units of all hierarchy levels (VC-4, VC3, VC-12 in the case of SDH) from each input to each output. In addition, there are also so-called 4/4 cross-connects such as, for example, the 1664SX of the Alcatel company, which are adapted for switching only multiplex units of the highest hierarchy level (in the case of SDN VC-4). The main item of this cross-connect is a space/time switching matrix which is connected to all input/output ports. In the case of the known systems, this switching matrix is in the form of a three-stage electrical switching matrix after Clos (see Clos, “A Study of Non-Blocking Switching Networks”, B.S.T.J. No. 32, 1953, pp. 406-424).

In addition, so-called optical cross-connects are currently being developed which are intended to switch optical communication signals of any format, such as SONET, ATM and IP. They comprise a central space switching matrix which is to be transparent to the communication signals to be switched. An example of such an optical cross-connect is presented in the article “Cost Effective Optical Networks: The Role of Optical Cross-Connects”, by Charles A. Brackett, which can be downloaded from the Internet site www.tellium.com.

More recent developments in optical communication transmission are directed at transmitting communication signals of increasingly higher bit rates. Thus, a new multiplex hierarchy known as “optical channel (OCh)” is currently under discussion. This new multiplex hierarchy is intended to have multiplex levels with bit rates of 2.66 Gbit/sec. and multiples (factor four) of that rate, namely, 10.7x Gbit/sec. and 43.x Gbit/sec. The future optical channels are intended, in particular, for optical communication transmission in wavelength division multiplex (WDM). This system is referred to as Optical Transport Network (OTN) and standardized in ITU-T G.709 (2001), which is incorporated by reference herein.

These optical channels also require cross-connects which are capable of switching communication signals of all hierarchy levels from each input to each output. For the switching matrix of such cross-connects, the approach with a three-stage electrical space/time matrix after Clos cannot be achieved at a warrantable cost, due to the high bit rate. Optical cross-connects with a transparent space switching matrix, however, are not capable of connecting ports for communication signals of a higher multiplex level to ports for communication signals of a lower multiplex level. On the other hand, such optical cross-connects are far from cost effective for the new optical channels.

### SUMMARY OF THE INVENTION

The object of the invention, therefore, is to provide a cross-connect for optical channels which supports full connectivity for communication signals of all multiplex levels. A further object of the invention is to disclose a method for switching optical channels of different multiplex levels.

The object is achieved by a cross-connect which is designed for the switching of so-called Optical Channels of different multiplex levels with respectively defined bit rates. The cross-connect has a number of input/output ports which are respectively adapted to transmit and receive communication signals of a particular multiplex level. The cross-connect furthermore has a space switching matrix which is adapted to switch communication signals of the lowest multiplex level, only. Input/output ports of the lowest multiplex level are connected directly to the switching matrix, and input/output ports of the higher multiplex levels are respectively connected to the switching matrix via a multiplexer which is adapted to multiplex a number of communication signals of the lowest multiplex level that are received from the switching matrix, so as to form a communication signal of the corresponding higher multiplex level, and to demultiplex a communication signal of the higher multiplex level that is received from the respective input/output port, so as to form a number of communication signals of the lowest multiplex level, and forward these individually to the switching matrix.

Advantageous refinements can be found in the dependent claims.

The invention has the advantage that the cross-connect can be expanded flexibly and, in relation to its capacity and the number of individual input/output ports, can be adapted to the intended application.

### BRIEF DESCRIPTION OF THE DRAWINGS

The invention will be explained in more detail below in an exemplary embodiment with reference to FIGS. 1 and 2, in which:

FIG. 1 shows the schematic structure of an optical cross-connect, and

FIG. 2 shows the structure of the cross-connect according to the invention.

### BRIEF DESCRIPTION OF THE DRAWINGS

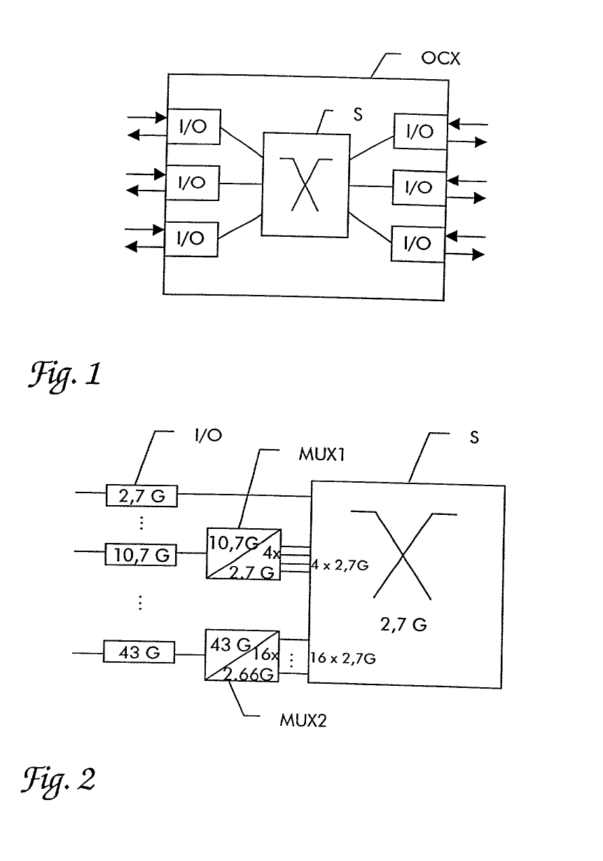

FIG. 1 presents the usual design of a cross-connect OCX. It comprises a number of optical input/output ports I/O, all of which are connected to a switching matrix S. The switching matrix S can thus switch each input to any output. In the case of known 4/3/1 cross-connects for SDH, the matrix is a space/time switching matrix which can switch any multiplex units, down to the lowest multiplex level, from any inputs to any outputs. In the case of known optical cross-connects, the switching matrix is a space switching matrix which is transparent to any signal formats. In these cases, however, only inputs of the same kind can be switched to outputs of the same kind. Thus, there would be no point in switching an ATM input to an STM-64 output, or the reverse.

According to the invention, the input/output ports I/O for communication signals are designed according to the definition of the optical channel (OCh,). These are based on a basic bit rate of 2.66 Gbit/sec., higher multiplex levels having four times the bit rate of the basic bit rate. Communication signals of a higher multiplex level are formed through byte-embedding of four communication signals of the respectively next-lower multiplex level, or directly contain a payload data signal. In the multiplexing of communication signals of a lower multiplex level to form a communication signal of a next-higher multiplex level, byte-stuffing is used to equalize frequency differences of the sub-signals. Hitherto, provision has been made for two higher multiplex levels, with bit rates of 10.7x Gbit/sec. and 43.x Gbit/sec. The exact bit rate has not yet been finally determined, so that the final effective bit rate position is denoted by x. It is assumed that further, higher multiplex levels will be determined in future.

A basic concept of the invention consists in using a single space switching matrix, which merely supports communication signals of the lowest multiplex level, and in sending communication signals of a higher multiplex level to the switching matrix via a multiplexer, which demultiplexes the communication signals of the higher multiplex level so as to form a number (4 or 16, respectively) of communication signals of the lowest multiplex level. Received communication signals of the lowest multiplex level are hence sent directly to the switching matrix, whereas communication signals of the higher multiplex levels are firstly decomposed by a multiplexer so as to form a plurality of communication signals of the lowest multiplex level. Now, if one or more communication signals of the lowest multiplex level are to be switched via the switching matrix to an output of a higher multiplex level, then they will in turn firstly be fed by the switching matrix to the multiplexer, which then interleaves the communication signals byte-wise so as to form a single communication signal of the higher multiplex level. The multiplexer hence provides the interface between the multiplex levels.

Such a cross-connect is represented in FIG. 2. It has a series of input/output ports IO1, IO2, IO3 for optical communication signals of the different multiplex levels, only one of each being represented for the sake of clarity. The input/output ports of the cross-connect can be subdivided into three groups: a first group of ports IO1 for communication signals of the lowest multiplex level, with a bit rate of 2.66 Gbit/sec, a second group of ports IO2 for communication signals of the second multiplex level, with a bit rate of 10.7x Gbit/sec, and a third group of ports IO3 for communication signals of the highest multiplex level, with a bit rate of 43.x Gbit/sec.

A switching matrix S is provided and adapted to switch communication signals of the lowest multiplex level with a bit rate of 2.66 Gbit/sec. The input/output ports of the first group IO1 for communication signals of the lowest multiplex level are linked directly to this switching matrix S. The cross-connect furthermore contains a first multiplexer MUX1 and a second multiplexer MUX2.

The first multiplexer MUX1 is provided for multiplexing communication signals of the lowest multiplex level so as to form communication signals of the second, middle multiplex level, and for the corresponding demultiplexing. The second multiplexer MUX2 is provided for multiplexing communication signals of the lowest multiplex level so as to form communication signals of the highest multiplex level, and for the corresponding demultiplexing. The multiplexer MUX1 has four ports for communication signals of the lower multiplex level, and one port for communication signals of the middle multiplex level. The four low bit-rate ports are respectively connected to ports of the space switching matrix S, and an input/output port of the second group IO2 for communication signals of the middle multiplex level is linked to the high bit-rate port. In similar fashion, the multiplexer MUX2 has sixteen ports for communication signals of the lower multiplex level, and one port for communication signals of the highest multiplex level. The sixteen low bit-rate ports are in turn respectively connected to ports of the space switching matrix S, and an input/output port of the third group IO3 for communication signals of the highest multiplex level is linked to the high bit-rate port.

The function of the cross-connect is as follows: the switching matrix switches connections for communication signals of the lowest multiplex level between any ports of the matrix. The switching state of the matrix is in this case determined by a control device (not shown) via a network management system.

Communication signals with a bit rate of 2.66 Gbit/sec are received at the ports of the first group IO1. If a communication signal is to be switched from such a port to a port of the same type in the same group IO1, then the switching matrix S switches this communication signal directly to the relevant port. Communication signals of higher multiplex levels, i.e. those from input/output ports of the second or third group IO2, IO3 for communication signals of the middle and highest multiplex levels, are firstly demultiplexed by the multiplexer MUX1 or MUX2 respectively located between the input/output port and the switching matrix S, so as to form communication signals of the lowest multiplex level, and are then forwarded to the switching matrix S via 4 or 16 parallel lines, respectively.

The case in which a communication signal of the lowest multiplex level (2.66 Gbit/sec) is to be switched from a port of the first group IO1 to a port of the second group IO2, will now be assumed as an example. To that end, the 2.66 Gbit/sec communication signal is switched by the switching matrix to the first multiplexer MUX1. As mentioned above, the multiplexer MUX1 has four ports for communication signals of the lowest multiplex level, and one port for signals of the middle multiplex level. The multiplexer interleaves the communication signals received at the four ports of the lowest multiplex level byte-wise so as to form a communication signal of the middle multiplex level, and forwards this to the input/output port of the second group IO2 for communication signals of the middle multiplex level. If the 2.66 Gbit/sec communication signal (described as an example) is the only communication signal which is to be switched to the relevant output, then the multiplexer interleaves it with three empty signals in order to form the communication signal of the middle multiplex level.

All switching states of the switching matrix S and the operating modes of the multiplexers MUX1 and MUX2 are bidirectional. For example, a communication signal from a port of the middle multiplex level can hence also be demultiplexed by the first multiplexer MUX1 so as to form four communication signals of the lowest multiplex level, and forwarded to the switching matrix S. The switching matrix S then switches these four communication signals to four different ports of the first group IO1.

If a communication signal of the lowest multiplex level is to be switched from a port of the first group IO1 to a port of the third group IO3, then it is firstly switched by the switching matrix S to the second multiplexer MUX2: the latter then forms, with fifteen other communication signals or also optionally with empty signals, a communication signal of the highest multiplex level which is then forwarded to the relevant output of the third group IO3 for communication signals of the highest multiplex level.

A communication signal of a higher multiplex level, which directly contains useful data and is to be switched to an input/output port of the same multiplex level, is likewise decomposed by the intermediate multiplexer, respectively so as to form four or 16 communication signals of the lowest multiplex level, each of the four or sixteen signals naturally containing a part of the original useful data. Via the switching matrix S, the four or sixteen subsidiary signals are then switched to a corresponding multiplexer of another input/output port of the same multiplex level, which then combines the subsidiary signals so as to re-form the original communication signal. A communication signal of a higher multiplex level is hence treated simply as if it were composed of communication signals of the lowest multiplex level. Since the data content of these virtual subsidiary signals is not changed by the switching matrix S, the original communication signal is recovered by subsequent multiplexing.

Likewise, a communication signal of the top multiplex level, which actually consists of four communication signals of the middle multiplex level, is assumed to consist of sixteen communication signals of the lowest multiplex level. Each quartet of such virtual subsidiary signals, which belong to a communication signal of the middle multiplex level, is then fed in parallel by the switching matrix S to the multiplexer MUX1, which then merges the four virtual subsidiary signals so as to re-form a communication signal of the middle multiplex level. This is possible since communication signals of a higher multiplex level are formed by byte-wise multiplexing from communication signals of a lower multiplex level.

A communication signal of a higher multiplex level is hence decomposed by inverse multiplexing so as to form subsidiary signals, which are then switched individually through the matrix. The term “inverse multiplexing” refers to a method of transmitting a signal with a higher data rate via a plurality of signals with a lower data rate.

The switching matrix S is advantageously embodied as an electrical switching matrix. The multiplexers likewise operate electrically. The input/output ports receive an optical signal and convert it into an electrical signal. The cross-connect according to the invention is advantageously constructed modularly in the form of plug-in circuit boards. It can therefore be expanded flexibly, e.g. by adding further plug-in multiplexer circuit boards and plug-in matrix circuit boards.

The use of two multiplexers is not intended to represent any limitation of the invention. Instead, a plurality of multiplexers of the same type may also be joined simultaneously between the switching matrix S and the input/output ports of the second or third group IO2, IO3. This is advantageous in the case of large switching matrices having a switching capacity of several dozen communication signals, so that a plurality of groups of ports of a lower multiplex level can be connected simultaneously to ports of a higher multiplex level. In this case, it is necessary to ensure that a separate multiplexer is provided for each input/output port of a higher multiplex level. The multiplexer may hence advantageously also be integrated into the respective input/output port.

What is claimes is:

1. An optical cross-connect for switching connections in an optical transmission network, in which optical communication signals of different multiplex levels with respectively defined bit rates can be transmitted, communication signals of a higher multiplex level being composed of communication signals of a lower multiplex level or directly containing a payload data signal; the cross-connect containing:
a number of input/output ports respectively adapted to transmit and receive communication signals of a particular multiplex level, and
a switching matrix connected to the input/output ports,
wherein the switching matrix is a space switching matrix which is adapted to switch communication signals of the lowest multiplex level, and wherein input/output ports of higher multiplex levels are linked to the switching matrix via a multiplexer which is adapted to multiplex a number of communication signals of the lowest multiplex level that are received from the switching matrix, so as to form a communication signal of the corresponding higher multiplex level, and to demultiplex a communication signal of the higher multiplex level that is received from the respective input/output port, so as to form a number of communication signals of the lowest multiplex level, and forward these individually to the switching matrix.

2. An optical cross-connect according to claim 1, in which the switching matrix is a transparent space switching matrix.

3. An optical cross-connect according to claim 2, in which the switching matrix is an optical space switching matrix.

4. An optical cross-connect according to claim 2, in which the switching matrix is an electrical space switching matrix.

5. An optical cross-connect according to claim 1, in which ports for a lowest hierarchy level, with a bit rate of 2.66 Gbit/sec, and two higher hierarchy levels, each with four times the bit rate of the hierarchy level immediately below, are respectively provided, in which input/output ports of the middle multiplex level are linked to the switching matrix via a first multiplexer, the first multiplexer being adapted to multiplex four communication signals of the lowest hierarchy level so as to form one communication signal of the middle hierarchy level, and vice versa, and in which input/output ports of the top multiplex level are linked to the switching matrix via a second multiplexer, the second multiplexer being adapted to multiplex sixteen communication signals of the lowest hierarchy level so as to form one communication signal of the highest hierarchy level, and vice versa.

6. Optical cross-connect according to claim 1, in which the subassemblies are embodied modularly in the form of plug-in circuit boards.

7. A method for switching optical communication signals of different multiplex levels with respectively defined bit rates, communication signals of a higher multiplex level being composed of communication signals of a lower multiplex level or directly containing a payload data signal, with the steps:
receiving an optical communication signal;
if the optical communication signal is a communication signal of a higher multiplex level, sending the communication signal to a multiplexer and demultiplexing the communication signal so as to form a number of communication signals of the lowest multiplex level;
sending the communication signals of the lowest multiplex level to a switching matrix;
identifying the output to which the received communication signal is to be switched;
if the communication signal is to be switched to an output which supports the lowest hierarchy level, switching the communication signal to the relevant output; and
if the communication signal is to be switched to an output which supports a higher hierarchy level,
switching the communication signal to a multiplexer,
multiplexing the communication signal so as to form a communication signal of the higher hierarchy level, and
forwarding the communication signal to the relevant output.
